(19) United States
(12) Patent Application Publication
(10) Pub. No.: US 2025/0170862 A1
(43) Pub. Date: May 29, 2025

(54) APPARATUS AND METHOD OF SENSING THE TIRE PRESSURE FOR VEHICLE

(71) Applicants: Hyundai Motor Company, Seoul (KR); Kia Corporation, Seoul (KR)

(72) Inventor: Hoon CHOI, Suwon-Si (KR)

(73) Assignees: Hyundai Motor Company, Seoul (KR); Kia Corporation, Seoul (KR)

(21) Appl. No.: 18/598,977

(22) Filed: Mar. 7, 2024

(30) Foreign Application Priority Data
Nov. 23, 2023 (KR) 10-2023-0164177

(51) Int. Cl. B60C 23/04; F16D 61/00

(52) U.S. Cl. CPC B60C 23/0411; B60C 23/0401; F16D 61/00

(57) ABSTRACT

An apparatus for detecting tire pressure of a vehicle may include: a power generation unit mounted on a wheel of the vehicle and generating power in response to operation of a brake pedal in the vehicle; a first wireless transmission unit operatively connected to the power generation unit and driven by the power produced by the power generation unit and transmitting a wake up signal; a pressure sensing unit operatively connected to the first wireless transmission unit and starting driving with the wake up signal received from the first wireless transmission unit; and an air pressure control unit operatively connected to the pressure sensing unit and receiving information detected by the pressure sensing unit.

### CROSS-REFERENCE TO RELATED APPLICATION(S)

The present application claims priority to Korean Patent Application No. 10-2023-0164177 filed on Nov. 23, 2023, the entire contents of which is incorporated herein for all purposes by this reference.

### BACKGROUND OF THE PRESENT DISCLOSURE

### Field of the Present Disclosure

The present disclosure relates to an apparatus and method of detecting tire pressure for a vehicle.

### Description of Related Art

As a tire-pressure monitoring system (TPMS) for a vehicle becomes legalized, rate of applying the TPMS for the vehicle is rapidly increasing.

The tire pressure monitoring system is largely divided into direct-type and indirect-type tire pressure monitoring systems depending on how the system operates. In the direct-type tire pressure monitoring system, an air pressure sensor is provided in a wheel inside a tire and an air pressure value measured using the same is transmitted to a controller (via RF communication) to determine whether tire pressure is abnormal, and in the indirect-type tire pressure monitoring system, a low-pressure tire is determined by use of a measurement value of a wheel speed sensor provided in the vehicle and referring to tire's radius characteristics and frequency characteristics.

However, the tire pressure monitoring system (TPMS) applied to conventional vehicles is causing various user complaints, depending on an installation structure and application thereof.

That is, there is a disadvantage that tire pressure is displayed only when the vehicle is driven, so there may be a problem in that pressure values for each tire position are not displayed on a cluster LCD window when the vehicle is started (not running) after being parked for a long time.

In other words, the tire pressure sensor wakes up only when an acceleration sensor inside the sensor detects rotation of the wheel after the vehicle is driven, and the pressure may be displayed after performing a tire position learning logic.

Therefore, because there is no separate wake-up method for the tire pressure sensor other than when the vehicle is driven, user complaints who want to check tire pressure when the vehicle is stopped rather than while the vehicle is driven are continuously occurring. In particular, tire pressure may decrease during night parking, and it is difficult to detect or take action on a low-tire pressure state before driving the vehicle the next day.

Accordingly, to enhance marketability of vehicles and reduce user complaints, an apparatus or method that can detect tire pressure using a novel method as compared to conventional tire pressure monitoring systems (TPMS) is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and method that can detect tire pressure for a vehicle by a simple apparatus even before a vehicle is driven.

Furthermore, an aspect of the present disclosure may provide an apparatus and method which may be easily implemented because installation of excessive parts is not required to measure tire pressure for a vehicle before the vehicle is driven.

The purpose of the present disclosure is not limited to the purposes mentioned above, and other purposes not mentioned will be clearly understood by those skilled in the art from the description below.

To achieve the above-described purpose, according to an aspect of the present disclosure, an apparatus for detecting tire pressure of a vehicle may include: a power generation unit mounted on a wheel of the vehicle and generating power in response to operation of a brake pedal in the vehicle; a first wireless transmission unit operatively connected to the power generation unit and driven by the power produced by the power generation unit and transmitting a wake up signal; a pressure sensing unit operatively connected to the first wireless transmission unit and starting driving with the wake up signal received from the first wireless transmission unit; and an air pressure control unit operatively connected to the pressure sensing unit and receiving information detected by the pressure sensing unit.

Furthermore, in an exemplary embodiment of the present disclosure, the apparatus for detecting tire pressure of a vehicle may include a power storage unit storing the power produced by the power generation unit.

Furthermore, in an exemplary embodiment of the present disclosure, the pressure sensing unit may use the power produced by the power generation unit.

Furthermore, in an exemplary embodiment of the present disclosure, the apparatus for detecting tire pressure of a vehicle may include a power amplification unit amplifying the power produced by the power generation unit and applying the power to the wireless transmission unit.

Furthermore, in an exemplary embodiment of the present disclosure, the apparatus for detecting tire pressure of a vehicle may include a display unit displaying the tire pressure information received from the air pressure control unit.

Furthermore, in an exemplary embodiment of the present disclosure, the air pressure control unit may be configured to determine whether tire pressure is abnormal based on the received tire pressure information.

Furthermore, in an exemplary embodiment of the present disclosure, when the air pressure control unit determines that the tire pressure is abnormal, tire pressure abnormality information is transmitted to the display unit, and the display unit may display the tire pressure abnormality information through a speaker or a display.

Furthermore, in an exemplary embodiment of the present disclosure, the apparatus for detecting tire pressure of a vehicle may include a second transmission unit transmitting the information from the pressure sensing unit to the air pressure control unit.

Furthermore, in an exemplary embodiment of the present disclosure, the power generation unit may include: a piston provided inside a caliper mounted on the wheel and applying pressure to a brake pad; and a piezoelectric element engaged to the piston and producing power due to movement of the piston.

Furthermore, in an exemplary embodiment of the present disclosure, the power generation unit may produce power by bending the piezoelectric element due to the movement of the piston.

Furthermore, in an exemplary embodiment of the present disclosure, the power generation unit may produce power by the pressure applied to the piezoelectric element due to the movement of the piston.

Furthermore, in an exemplary embodiment of the present disclosure, the generation unit may include: a piston provided inside a caliper mounted on the wheel and applying pressure to a brake pad; and a magnetic and coil, wherein one of the magnetic and coil is connected to the movement of the piston, and the other of the magnet and the coil is provided in the caliper and produces power through mutual electromagnetic induction due to the movement of the piston.

To achieve the above-described purpose, according to an aspect of the present disclosure, a method for detecting tire pressure of a vehicle according to an exemplary embodiment of the present disclosure may include: a power generation operation in which power is produced in response to operation of a brake pedal in the vehicle; a first wireless transmission operation in which a wake up signal is transmitted using the power produced in the power generation operation; a tire pressure detecting operation in which a pressure sensing unit starts to detect tire pressure with the received wake up signal; and an abnormality determination operation in which an air pressure control unit is configured to determine whether the tire pressure is abnormal with the information detected by the pressure sensing unit.

Furthermore, in an exemplary embodiment of the present disclosure, a power detecting operation of detecting that power is applied to a vehicle before the power generation operation may be included, wherein the power generation operation may be performed after detecting that power is applied to the vehicle in the power detecting operation.

Furthermore, in an exemplary embodiment of the present disclosure, a second wireless transmission operation of transmitting tire pressure information detected in the tire pressure detecting operation to the air pressure control unit may be included.

In an exemplary embodiment of the present disclosure, the abnormality determination operation may determine whether the tire pressure is abnormal based on the received tire pressure information.

Furthermore, in an exemplary embodiment of the present disclosure, when it is determined that the tire pressure is abnormal in the abnormality determination operation, a display operation of displaying tire pressure abnormality information through a speaker or a display may be included.

Furthermore, the method for detecting tire pressure of a vehicle according to an exemplary embodiment of the present disclosure may be stored in a computer-readable storage medium on which a program for execution on a computer is recorded.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a conceptual diagram of an apparatus for detecting tire pressure of a vehicle according to an exemplary embodiment of the present disclosure.

FIG. 2 is a conceptual diagram illustrating an example of a power unit in an apparatus for detecting tire pressure according to an exemplary embodiment of the present disclosure.

FIG. 3 is a reference diagram illustrating a schematic structure of an apparatus for detecting tire pressure according to an exemplary embodiment of the present disclosure.

FIGS. 4A, FIG. 4B, FIG. 5A and FIG. 5B are reference diagrams illustrating a power generation structure using a piezoelectric element in an apparatus for detecting tire pressure according to an exemplary embodiment of the present disclosure.

FIG. 6 is a reference diagram illustrating a power generation structure using a coil and a magnet in an apparatus for detecting tire pressure according to an exemplary embodiment of the present disclosure.

FIG. 7 and FIG. 8 are conceptual diagrams of a method for detecting tire pressure according to an exemplary embodiment of the present disclosure.

FIG. 9 is a reference diagram showing a schematic structure of a method for detecting tire pressure according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Because the present disclosure may have various changes and may have various exemplary embodiments of the present disclosure, specific embodiments may be illustrated in the drawings and described in detail. However, this is not intended to limit the present disclosure to specific embodiments, it should be understood to include all modifications, equivalents, and substitutes included in the spirit and technical scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of the plurality of related listed items.

Terms such as “unit, part, portion, and the like” may be used to describe various components, but the components should not be limited by the above-described terms. The above-described terms may be terms not only referring to describing a physically/visually distinct component, but also terms referring to describing the function or component of the corresponding portion even if is not clearly divided or demarcated.

The terms used in the present application may be only used to describe specific embodiments, and are not intended to limit the present disclosure. The singular expression may include the plural expression, unless the context clearly dictates otherwise. In the present application, it should be understood that terms such as “include,” “comprise,” or “have” are intended to designate that features, numerals, steps, operations, components, parts, or combination thereof described in the specification exists, but one or more other features this does not preclude the existence or addition of numbers, steps, operations, components, parts, or combinations thereof.

Unless defined otherwise, all terms used herein, including technical or scientific terms, have the same meaning as that which can commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal manner unless explicitly defined in the present application.

In the present specification, a vehicle refers to a variety of vehicles for moving an object to be transported, such as people, animals, or goods, from a starting point to a destination. These vehicles are not limited to vehicles running on roads or tracks.

In the description below, the terms “frontward”, “backward”, “lateral”, “front”, “back”, “up/down”, “above”, “upper”, “upper portion”, “below”, “lower”, “lower portion”, “left and right”, and the like used in relation to direction are defined based on a vehicle or a vehicle body. Furthermore, terms such as first, second, and the like may be used to describe various components, but these components are not limited in order, size, location, or importance by terms such as first second, and the like, and the terms such as first and second are named only for distinguishing one component from another component.

Hereinafter, exemplary embodiments of the present disclosure will be described in more detail with reference to the accompanying drawings.

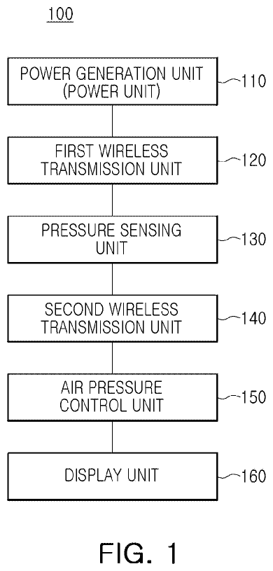

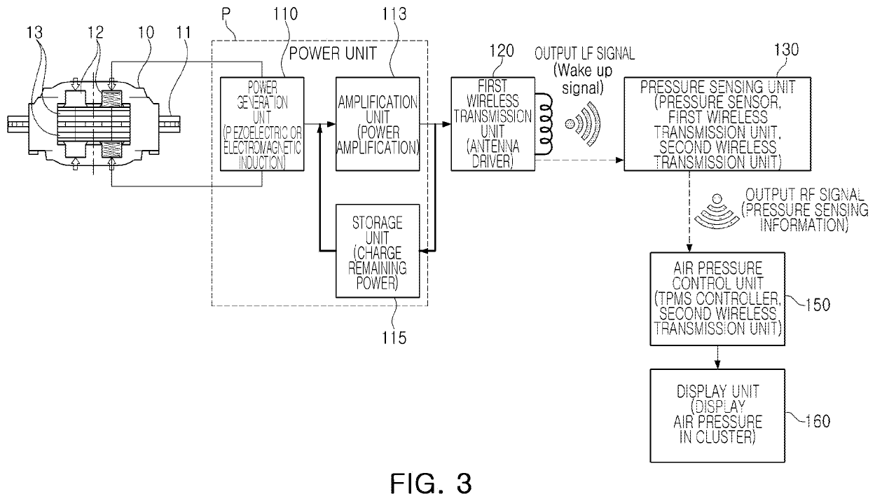

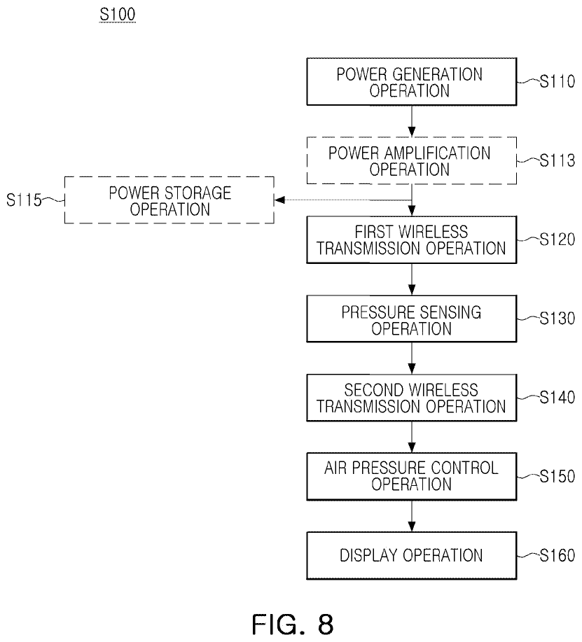

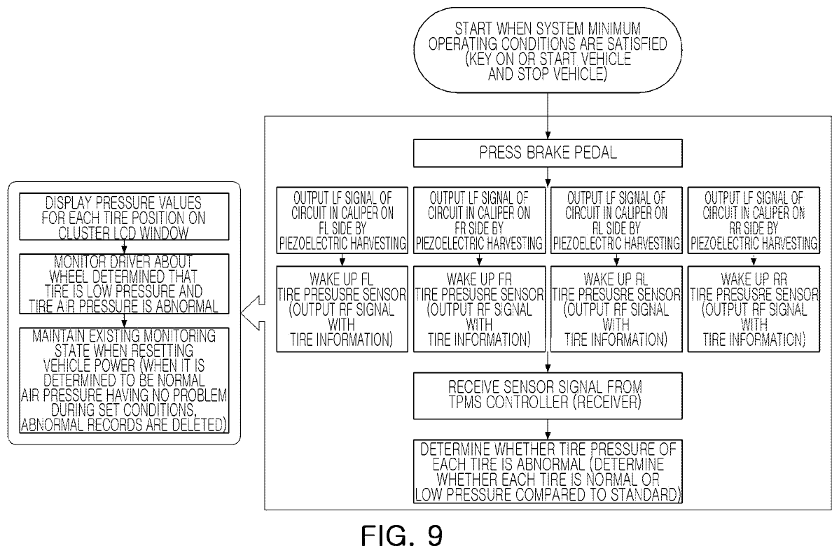

Referring to FIGS. 1, 3, 8, and 9, an apparatus 100 or method (S100) for detecting tire pressure of a vehicle in an exemplary embodiment of the present disclosure may be an apparatus or method that can measure air pressure of a vehicle in advance before the vehicle is driven.

The conventional tire pressure monitoring system (TPMS) could measure tire pressure only after starting the vehicle and driving, which was designed to solve the problem of not being able to respond in advance to a case in which the vehicle's air pressure is low before the vehicle is driven.

In an exemplary embodiment of the present disclosure, an apparatus configured for outputting a low frequency (LF) signal using a generator (piezoelectric harvesting using piezoelectric elements or electromagnetic induction using coils and magnets) mounted inside a brake caliper may be implemented, and information on a tire pressure sensor may be transmitted via a radio frequency (RF) by pressing the brake pedal by a driver even when the vehicle is initially started or before the vehicle is driven after starting. When the tire pressure sensor information is transmitted through RF, a TPMS controller (receiver) receiving the signal may transmit and display the detecting information to the cluster, of course, which includes all air pressures for each tire position.

Hereinafter, the apparatus for detecting tire pressure of a vehicle 100 will first be described with reference to FIG. 1, and the method for detecting tire pressure of a vehicle (S100) will be described later.

Referring to FIG. 1, the apparatus for detecting tire pressure of a vehicle 100 in an exemplary embodiment of the present disclosure may include, at least, a power generation unit 110, a first wireless transmission unit 120, a pressure sensing unit 130, and an air pressure control unit 150. Furthermore, the apparatus for detecting tire pressure of a vehicle 100 may also include a second wireless transmission unit 140 or a display unit 160.

In the appended drawings, a control unit (central control unit) and a storage unit are omitted, but in an exemplary embodiment of the present disclosure, a control unit for controlling the apparatus for detecting tire pressure of a vehicle 100 and the method for detecting tire pressure of a vehicle (S100) may be provided, and a storage unit for storing information may be provided. For example, the control unit may be connected to the apparatus for detecting tire pressure of a vehicle 100, and may be connected to the power generation unit 110, the first wireless transmission unit 120, the pressure sensing unit 130, the air pressure control unit 150, and the second wireless transmission unit 140 or the display unit 160 to participate in the control of these components. Meanwhile, the air pressure control unit 150 may perform the role of the central control unit, and in the instant case, a central control unit may not be separately provided.

In an exemplary embodiment of the present invention, the second wireless transmission unit 140 is configured for transmitting the information from the pressure sensing unit 130 to the air pressure control unit 150.

The apparatus for detecting tire pressure of a vehicle 100 may produce power inside a caliper by a driver operating a brake pedal during an initial start of a vehicle in a non-driving state after the initial start of a vehicle, and in the instant case, the power generated may be used to transmit a signal to a pressure sensor to measure tire pressure. The measured pressure may be displayed in a cluster or displayed as an alarm.

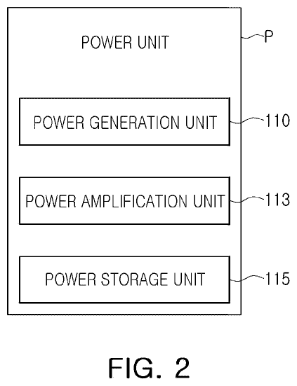

Referring to FIGS. 1 to 6, the power generation unit 110 may be provided on a wheel and can generate power (power production) in response to operation of a brake pedal. Furthermore, the power produced in the power generation unit 110 may be amplified by an amplification circuit in the power amplification unit 113, and after the power is used in a first wireless transmission unit 120 described below, the power may be stored in a power storage unit 115 (battery). The power storage unit 115 may be a battery provided inside a circuit, and the remaining power produced by the power generation unit 110 and used in the first wireless transmission unit 120 may be continuously stored in the power storage unit 115.

In an exemplary embodiment of the present disclosure, the apparatus for detecting tire pressure of a vehicle 100 may include a power unit P, and the power unit P may include at least one of a power generation unit 110, a power amplification unit 113, and a power storage unit 115.

At least a portion of the components of the exemplary embodiment, such as the power generation unit 110, the first wireless transmission unit 120, the pressure sensing unit 130, the air pressure control unit 150, the second wireless transmission unit 140, or the display unit 160 may be driven by the power of the power storage unit 115. When power is applied to a vehicle, it may be driven by the power of the battery provided in the vehicle.

The power generation unit 110 may be provided in a caliper 10 implementing a brake of the vehicle. The caliper 10 may include a brake pad 13 applying frictional force to a disc rotor 11 provided on the rotating wheel, and the brake pad 13 may be pressed by operating the brake pedal to contact with the disc rotor 11. The brake pad 13 may be connected to a piston 12, and may be provided with a power generation unit 110 producing power by compression of the piston 12.

The power generation unit 110 may be piezoelectric elements 20 and 30 or a coil & magnet apparatus 40. The piezoelectric elements 20 and 30 may be connected to the piston 12 are bent or compressed as the piston 12 is compressed, producing power by piezoelectric harvesting.

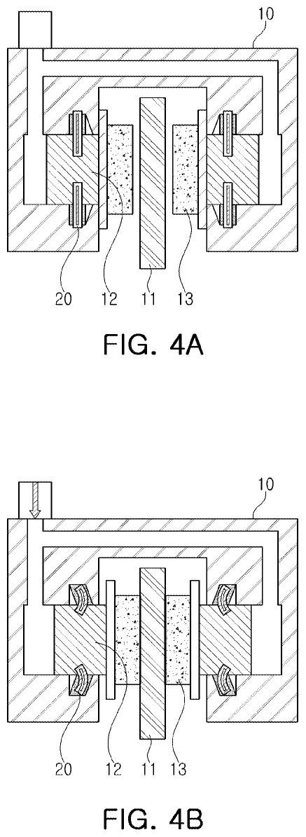

That is, referring to FIG. 4A and FIG. 4B, the piezoelectric element 20 may be connected to the piston 12, and as the piston 12 is compressed, a structure in which power is produced by bending of the piezoelectric element 20 is disclosed. As shown in FIG. 4B, the piezoelectric element 20 connected to the piston 12 may be bent as the piston 12 is compressed, producing power.

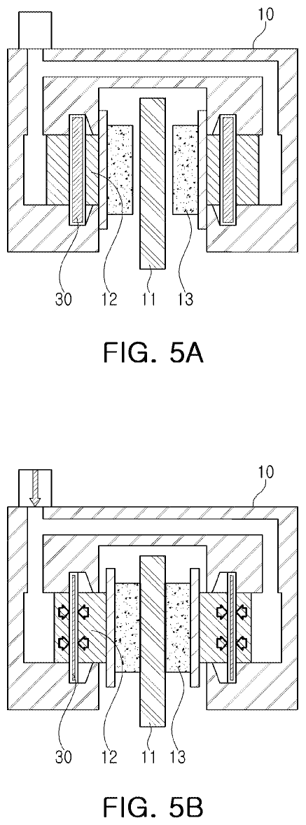

Furthermore, referring to FIG. 5A and FIG. 5B, the piezoelectric element 30 is linked to the piston 12, and as the piston 12 is compressed, a structure in which the piezoelectric element 30 may be pressurized, producing power is disclosed. As shown in FIG. 5B, the piezoelectric element 30 connected to the piston 12 may receive pressure as the piston 12 is compressed, producing power.

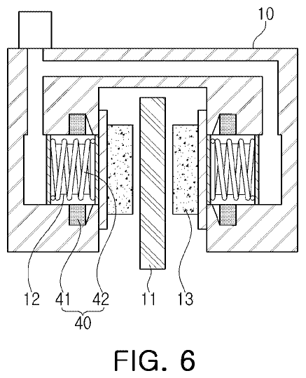

Furthermore, referring to FIG. 6, one of the coil & magnet apparatus 40 including magnets 41 and coils 42 may be linked to movement of the piston 12, and the other thereof may be provided in the caliper 10 and may produce power through mutual electromagnetic induction due to the movement of the piston 12. In the illustration of FIG. 6, a structure in which the magnet 41 is fixed to the caliper 10 and the coil 42 is wound around the piston 12 (a specific winding structure is omitted) is disclosed, which is merely an example, and may be also provided in an opposite manner.

The first wireless transmission unit 120 may be driven by the power produced by the power generation unit 110 and transmit a wake up signal to the pressure sensing unit 130 (e.g., tire pressure sensor, or the like) provided in each wheel. The first wireless transmission unit 120 may be an antenna driver and may transmit a wireless signal (e.g., a low frequency (LF) signal, or the like).

The pressure sensing unit 130 (e.g., tire pressure monitoring system (TPMS), or the like) receiving an LF signal may be woke up to transmit detecting information inside the tire (air pressure, temperature, acceleration, or the like, for each tire position) to the air pressure control unit (TPMS controller and receiver) through a wireless signal (e.g., a Radio Frequency (RF) signal, or the like).

The pressure sensing unit 130 may include a first wireless reception unit receiving a wireless signal from the first wireless transmission unit 120 and a second wireless transmission unit transmitting a signal to the air pressure control unit 150. A pressure sensor detecting tire pressure of each wheel may also be provided.

The pressure sensing unit 130 may start driving with a wake up signal received from the first wireless transmitter 120, receive the corresponding wake up signal, and detect the tire pressure of each wheel, and transmit the same to the air pressure control unit 150.

The air pressure control unit 150 may perform overall control of the tire pressure control system (TPMS), and may be provided with a second wireless reception unit to receive a wireless signal from the pressure sensing unit 130. The second wireless reception unit may receive a wireless signal (e.g., RF signal, or the like) transmitted from the pressure sensing unit 130.

The air pressure control unit 150 may be configured to determine whether the tire pressure is abnormal based on the received tire pressure information. For example, the tire pressure is abnormal when the tire pressure is lower than suggested tire pressure by the manufacturer. When the air pressure control unit 150 determines that the tire pressure is abnormal, tire pressure abnormality information may be transmitted to a display unit 160, and the display unit 160 may display (alarm) the information through a speaker, display, or the like.

The display unit 160 may display tire pressure information received from the air pressure control unit. The display unit 160 may be any device displaying computer information so that the user can recognize it, such as a monitor (display), cluster, speaker, steering wheel or the like. So, the pressure information may be received by a displaying, a speaking or a physical vibration or the like.

Next, a method of detecting tire pressure for a vehicle (S100) which may be implemented using at least a portion of the apparatus 100 of detecting tire pressure for a vehicle described above will be described.

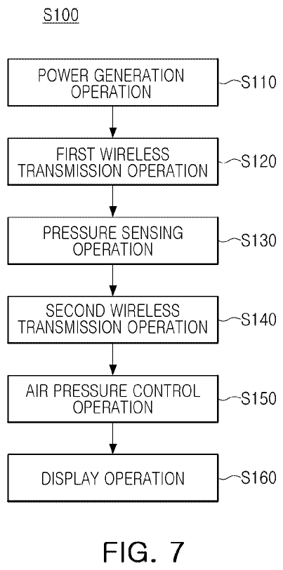

Referring to FIGS. 7 to 9, the method of detecting tire pressure for a vehicle (S100) according to the exemplary embodiment may be a method that can measure air pressure of a vehicle in advance even before the vehicle is driven.

The method for detecting tire pressure of a vehicle (S100) of an exemplary embodiment of the present disclosure may include at least a power generation operation (S110), a first wireless transmission operation (S120), a pressure detecting operation (S130), and an air pressure control operation (S150). Furthermore, the method for detecting tire pressure of a vehicle (S100) may also include a second wireless transmission operation (S140) or a display operation (S160).

Furthermore, before the power generation operation (S110), the method of detecting tire pressure for a vehicle (S100) may include a power detecting operation of detecting that power is applied to the vehicle, and the power generation operation (S110) may be performed after detecting that power is applied to the vehicle in the power detecting operation. Here, power being applied to the vehicle may mean 1) a vehicle's key is in a position at which a vehicle starts (on position) to drive, or 2) the vehicle is started (engine or motor start) but before the vehicle starts to drive.

Although a control unit is not shown in the appended drawings, in an exemplary embodiment of the present disclosure, a control unit (central control unit) for controlling the apparatus for detecting tire pressure of a vehicle 100 and the method for detecting tire pressure of a vehicle (S100) may be provided, and overall control may be performed by the control unit. For example, the control unit may be related to controlling the method for detecting tire pressure of a vehicle (S100), and the control unit may be related to the control of the power generation operation (S110), the first wireless transmission operation (S120), the pressure detecting operation (S130), the air pressure control operation (S150), the second wireless transmission operation (S140), or the display operation (S160), and the control unit may be connected to the power generation unit 110, the first wireless transmission unit 120, the pressure sensing unit 130, the air pressure control unit 150, the second wireless transmission unit 140, or the display unit 160 and may be related to the control of these components. Meanwhile, the air pressure control unit 150 may perform a role of the central control unit, and in the instant case, a separate central control unit may not be provided.

According to the method for detecting tire pressure of a vehicle (S100) of the exemplary embodiment, power may be generated inside the caliper by a driver operating a brake pedal during an initial start of the vehicle or in a non-driving state after the initial start of the vehicle, and the power generated at the instant time may be used to measure tire pressure using the signal received in the pressure detecting operation. The measured pressure may be displayed on a cluster or as an alarm in the display operation.

Referring to FIGS. 7 to 9, in the power generation operation (S110), for example, the power generation unit 110 may be provided on a wheel and generate power (electric power production) in response to operation of a brake pedal in the vehicle. Furthermore, the power produced in the power generation operation (S110) may be amplified in the power amplification operation (S113), for example, by an amplification circuit, and the power may be used in a first wireless transmission operation (S120) described later, and then stored in the power storage operation (S115), for example, in a power storage unit 115 (battery).

The power storage unit 115 may be a battery provided inside a circuit, and the remaining power produced in the power generation operation (S110) and used in the first wireless transmission operation (S120) may be continuously stored in the storage unit 115 in the power storage operation (S115).

In the power generation operation (S110), power may be produced using the piezoelectric elements 20 and 30 or the coil & magnet apparatus 40 provided in the caliper 10. Since the specific power production method was described above with reference to FIGS. 1 to 6, description thereof will be omitted.

In the first wireless transmission operation (S120), a wake up signal may be transmitted with the power produced in the power generation operation (S110) to a pressure sensing unit 130 (e.g., tire pressure sensor, or the like) provided in each wheel. In the first wireless transmission operation (S120), a wireless signal (e.g., low frequency (LF) signal, or the like) may be transmitted.

The pressure sensing unit 130 (e.g., tire pressure monitoring system (TPMS), or the like) receiving an LF signal may be woke up to transmit detecting information inside the tire (air pressure, temperature, acceleration, or the like, for each tire position) to the air pressure control unit (TPMS controller and receiver) through a wireless signal (e.g., a Radio Frequency (RF) signal, or the like).

The pressure sensing unit 130 may include a first wireless reception unit receiving a wireless signal from the first wireless transmission unit 120 and a second wireless transmission unit transmitting a signal to the air pressure control unit 150. The pressure sensing unit 130 may also include a pressure sensor of detecting tire pressure of each wheel.

The pressure detecting operation (S130) may be performed with a wake up signal received in the first wireless transmission operation (S120), and the tire pressure of each wheel may be detected by the wake up signal and transmitted to the air pressure control unit 150.

The air pressure control operation (S150) may perform overall control of the tire pressure monitoring system (TPMS). In the air pressure control operation (S150), tire pressure information may be received from the pressure sensing unit 130 through a wireless signal.

The air pressure control operation (S150) may be configured to determine whether the tire pressure is abnormal based on the received tire pressure information, and if the tire pressure is determined to be abnormal in the air pressure control operation (S150), the tire pressure abnormality information may be transmitted to a display unit 160, and the display unit 160 may display the tire pressure abnormality information through a speaker, display, steering wheel or the like. For example, the tire pressure is abnormal when the tire pressure is lower than suggested tire pressure by the manufacturer. And, the pressure information may be received by a displaying, a speaking or a physical vibration or the like.

The display operation (S160) may display tire pressure information received from the air pressure control unit. In the display operation (S160), tire pressure information may be displayed on any device displaying computer information such as a monitor (display), cluster, or speaker so that the user can perceive it.

The methods according to an exemplary embodiment of the present disclosure may be implemented in a form of program instructions which may be executed by various computer means and recorded on a computer readable medium. The computer readable medium may include program instructions, data files, data structures, and the like, alone or in a combination thereof. Program instructions recorded on a computer readable medium may be specially designed and configured for the present disclosure may be known to those skilled in computer software and used.

Examples of the computer readable medium include hardware devices specially configured to store and execute program instructions, such as ROM, RAM, flash memory, and the like. Examples of the program instructions include high-level language codes which may be executed by a computer using an interpreter, or the like as well as machine language codes generated by a compiler. The hardware device described above may be configured to operate with at least one software module to perform the operations of the present disclosure, and vice versa.

The apparatus for detecting tire pressure of a vehicle 100 of the exemplary embodiment may include a storage unit. The storage unit is a recording medium suitable for storing the apparatus for detecting tire pressure of a vehicle 100, and the storage unit may include, for example, magnetic media such as a hard disk, a floppy disk, and a magnetic tape, optical media such as compact disk read only memory (CD-ROM), and a digital video disk (DVD), magneto-optical media such as a floptical disk, and a semiconductor memory such as a flash memory or erasable programmable ROM (EPROM), or an SSD manufactured based thereon.

It may be implemented through a non-volatile memory configured to store data relating to algorithms configured to control operations of various components of the vehicle or software instructions reproducing the algorithms; and a processor configured to perform the operations described above or below using data stored in the corresponding memory. Here, the memory and processor may be implemented as individual chips. Alternatively, the memory and processor may be implemented as a single chip integrated with each other. A processor may take a form of one or more processors.

Components of the apparatus for detecting tire pressure of a vehicle 100 may be connected wired and wirelessly to exchange information using a network provided in a vehicle. In the method for detecting tire pressure of a vehicle (S100), information may also be exchanged wired or wirelessly using a network provided in the vehicle. For example, data may be exchanged using a network communication means provided in the vehicle such as Ethernet, Media Oriented Systems Transport (MOST), Flexray, Controller Area Network (CAN), Local Interconnect Network (LIN), Internet, LTE, 5G, Wi-Fi, Bluetooth, adjacent to Field Communication (NFC), Zigbee, Radio Frequency (RF), predetermined Frequency (LF), and the like.

As set forth above, according to an exemplary embodiment of the present disclosure, according to an apparatus and method of detecting a tire pressure for a vehicle according to an exemplary embodiment of the present disclosure, the tire pressure of the vehicle may be detected using a simple apparatus even before the vehicle is driven.

Furthermore, in an exemplary embodiment of the present disclosure, the tire pressure of the vehicle before the vehicle is driven may be measured simply and relatively accurately without installation of excessive portions.

The effects of the present disclosure are not limited to those described above, and other effects not mentioned will be clearly recognized by those skilled in the art from the description below.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for detecting tire pressure for a vehicle, the apparatus comprising:
a power generation unit mounted on a wheel of the vehicle and generating power in response to operation of a brake pedal in the vehicle;
a first wireless transmission unit operatively connected to the power generation unit and driven by the power produced by the power generation unit and transmitting a wake up signal;
a pressure sensing unit operatively connected to the first wireless transmission unit and starting driving with the wake up signal received from the first wireless transmission unit; and
an air pressure control unit operatively connected to the pressure sensing unit and receiving information detected by the pressure sensing unit.

2. The apparatus of claim 1, further including a power storage unit operatively connected to the power generation unit and storing the power produced by the power generation unit.

3. The apparatus of claim 1, wherein the pressure sensing unit utilizes the power produced by the power generation unit.

4. The apparatus of claim 1, further including a power amplification unit operatively connected to the power generation unit, amplifying the power produced by the power generation unit and applying the power to a wireless transmission unit operatively connected to the power amplification unit.

5. The apparatus of claim 1,
wherein the information includes tire pressure information, and
wherein the apparatus further includes a display unit operatively connected to the air pressure control unit and displaying the tire pressure information received from the air pressure control unit.

6. The apparatus of claim 1, wherein the air pressure control unit is configured to determine whether the tire pressure is abnormal, with the received tire pressure information.

7. The apparatus of claim 6, wherein upon concluding that the tire pressure is abnormal, the air pressure control unit is configured to transmit tire pressure abnormality information to the display unit, and the display unit displays the tire pressure abnormality information through a speaker or a display.

8. The apparatus of claim 1, further including a second wireless transmission unit transmitting the information from the pressure sensing unit to the air pressure control unit.

9. The apparatus of claim 1, wherein the power generation unit includes:
a piston provided inside a caliper mounted on the wheel and applying a pressure to a brake pad of the brake pedal; and
a piezoelectric element engaged to the piston and producing the power due to movement of the piston.

10. The apparatus of claim 9, wherein the power generation unit produces the power in response to bending of the piezoelectric element due to the movement of the piston.

11. The apparatus of claim 9, wherein the power generation unit produces the power in response to the pressure applied to the piezoelectric element due to the movement of the piston.

12. The apparatus of claim 1, wherein the power generation unit includes:
a piston provided inside a caliper mounted on the wheel and applying a pressure to a brake pad of the brake pedal; and
a magnet and a coil, wherein one of the magnet and the coil is engaged to movement of the piston, and the other of the magnet and the coil is provided in the caliper and produces the power through mutual electromagnetic induction due to the movement of the piston.

13. A method for detecting tire pressure for a vehicle, the method comprising:
a power generation operation in which power is produced in response to operation of a brake pedal in the vehicle;
a first wireless transmission operation in which a wake up signal is transmitted using the power produced in the power generation operation;
a tire pressure detecting operation in which a pressure sensing unit starts to detect tire pressure with the received wake up signal; and
an abnormality determination operation in which an air pressure control unit is configured to determine whether the tire pressure is abnormal with information detected by the pressure sensing unit.

14. The method of claim 13, further including:
a power detecting operation of detecting that the power is applied to the vehicle, before the power generation operation,
wherein the power generation operation is performed after detecting that the power is applied to the vehicle in the power detecting operation.

15. The method of claim 13,
wherein the information includes tire pressure information, and
wherein the method further includes a second wireless transmission operation of transmitting the tire pressure information detected in the tire pressure detecting operation to the air pressure control unit.

16. The method of claim 15, wherein in the abnormality determination operation, whether the tire pressure is abnormal is determined with the received tire pressure information.

17. The method of claim 13, wherein upon concluding that the tire pressure is abnormal in the abnormality determination operation, the method further includes a display operation of displaying tire pressure abnormality information through a speaker or a display.

18. A non-transitory computer-readable storage medium recording a program for executing the method for detecting tire pressure for a vehicle, of claim 13 on a computer.
